(19) United States
(12) Patent Application Publication
(10) Pub. No.: US 2004/0056427 A1
(43) Pub. Date: Mar. 25, 2004

(54) Lip seal

(75) Inventors: Oskar Rapp, Humes (FR); Eric Kammerer, Langres (FR)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/630,421

(22) Filed: Jul. 30, 2003

(30) Foreign Application Priority Data
Jul. 31, 2002 (DE) DE102 35 079.5-12

(51) Int. Cl. F16J 15/32

(52) U.S. Cl. 277/549

(57) ABSTRACT

A lip seal for sealing the gap between a housing and a shaft, a seal having a supporting body and static and dynamic sealing elements attached to the supporting body, the sealing elements being made of different materials and the supporting body having an annular part oriented radially to the shaft and a cylindrical part running axially to the shaft. The dynamic sealing element (7) is fastened to the radial annular part (31) of the supporting body and encloses the annular part (31) on both sides at the fastening point (32). The static sealing element (6) is positioned on the axial cylindrical part (33) of the supporting body (5) at a radial distance (8) from the dynamic sealing element (7).

Priority to German Patent Application No. 102 35 079.5-12, filed Jul. 31, 2002 and hereby incorporated by reference herein, is claimed.

### BACKGROUND INFORMATION

The present invention relates to a lip seal for sealing the gap between a housing and a shaft, a lip seal having a supporting body and static and dynamic sealing elements attached to the supporting body, the sealing elements being made of different materials and the supporting body having an annular part oriented radially to the shaft and a cylindrical part running axially to the shaft.

A lip seal that has a supporting body to which the static seal is attached was disclosed by German Patent Application No. 198 36 986 A1. The supporting body has an annular part oriented radially to the shaft and a cylindrical part running axially to the shaft. The static seal, while remaining of uniform material, merges into a front-mounted seal that bears dynamically against the shaft. On the axial inside of the static seal is mounted a sealing body made of PTFE that represents the dynamic seal for the space to be sealed off and curves forward in the direction of the space to be sealed off.

Another form of a comparable seal is shown in German Patent Application No. 197 40 822 A1. Here, too, a supporting ring of an approximately comparable type is used, to which a static seal and a dynamic seal are fastened. These seal materials can be made of one and the same material; however, it is also possible to manufacture them from different materials.

### BRIEF SUMMARY OF THE INVENTION

The present invention is based on an object of developing the known seals so that an increased service life is possible with reduced manufacturing costs. At the same time, a goal is to improve the functional properties. A final alternate or additional goal is that the new seal is cost-effective to manufacture.

The present invention provides that the dynamic sealing element is fastened to the radial annular part of the supporting body and encloses the annular part on both sides at the fastening point, and that the static sealing element is positioned on the axial cylindrical part of the supporting body at a radial distance from the dynamic sealing element. The thickness of the dynamic sealing element at the fastening point may be equal or different on both sides. In this case, only a portion of the radial annular part, namely the inside edge of the annular part, is used by the dynamic seal as a connection point. The static sealing element, in contrast, is limited to a connection that essentially includes the axial cylindrical part of the supporting body. Between the static sealing element and the dynamic sealing element, a radial distance is maintained that allows both sealing elements to be manufactured from very different materials during the manufacturing process, a process in which vulcanization of the elastomeric material on the supporting body may be carried out at the same time for both sealing elements.

The supporting body is manufactured from a tough and hard material, preferably from metal.

For the radial distance of the static sealing element from the dynamic sealing element, as much space is chosen as is necessary for reasons of manufacturing engineering. The space amounts to at least 0.5 mm, so that appropriate spacers may be inserted at the specified points. The spacers are ring-shaped spacer projections located opposite one another in the mold. At the same time, this procedure has the advantage that the supporting body may be kept in a defined position during vulcanization. In this case, vulcanization may be carried out by using coupling agents. The particular coupling agent that is used fixes the two different materials to the supporting body.

Shapes and materials that make it possible for the lip shape of the sealing element to be formed only during the sliding of the seal onto the shaft are preferably used for the dynamic sealing elements. Before sliding onto the shaft, the dynamic sealing element is an annular disk, preferably of constant thickness. It is advantageous in this case if the dynamic sealing element, at least in the area of the lip that encloses the shaft, is provided with openings on its surface facing the shaft for return delivery of the medium to be sealed off. In such a case, the edge of the dynamic sealing element is provided with a barrier feature so that the medium to be sealed off will not be able to flow out when the shaft is at rest.

Moreover, the dynamic sealing element may be provided with concentric or screw-shaped openings on its surface facing away from the shaft that facilitate easier curving of the lip during assembly. These openings are preferably adapted to the openings on the opposite inside surface. The openings on both sides may be single-threaded or multiple-threaded.

In order to make it possible for the static sealing element to be inserted into the housing opening from both directions, the sealing element has an end chamfer and/or a bottom chamfer on its outside surface. The outside surface of the static sealing element is preferably corrugated in order to make good adhesion to the inside wall of the housing opening possible. The press-in force into the housing opening and the press-out force from the housing opening are controlled by the corrugation design.

In another embodiment of the present invention, the shaft may be provided with a multipole wheel that works together with a sensor attached to the housing in order to transmit rotational speed measurements, for example, and also other measured data.

A quality advantage and a cost advantage are achieved by the present invention. The quality advantage lies in the fact that each of the two materials may be optimized with respect to its requirements in operation. The cost advantage is established by the fact that the more expensive material (generally at the dynamic sealing point) only has to be used where it is absolutely required.

The material for the dynamic sealing element is optimized with respect to sealing off the rotating machine part. Especially stringent requirements for thermal stability have to be imposed since frictional heat is a factor in addition to the heating caused by the oil bath. The consequence is an extremely high purchase price. Substances that sharply reduce friction such as waxes or paraffins may also be incorporated into this material. Such substances should not be present in the material for the static sealing element since the force fit might then be lost and the gasket would move in its hole. A fluororubber (FPM) has proved effective, for example, as the material for the dynamic sealing element.

The material for the static sealing element is optimized with respect to sealing off the stationary machine part. Since in this case no frictional heat is added, the requirements for thermal stability are less stringent. Thus a comparatively low-cost material may be used. The material is developed for a good force fit and low compression set. A surface coating for dry assembly is possible. An acrylic rubber (ACM), for example, has proved effective. The sealing elements are preferably made of a polymer such as an elastomer or a crosslinkable thermoplastic, for example. Alternative materials for the lip of the gasket are also a thermoplastic or thermoset material. For example, PPS (polyphenylene sulfide), PA (polyamide), moldable copolymers like FEP (perfluoroethylene propylene) or PFA (perfluoroalkoxy copolymer) or a thermoplastic elastomer may also be used. Finally, it is advantageous if the material of the static sealing area and the material of the dynamic sealing area are colored differently.

### BRIEF DESCRIPTION OF THE DRAWING

A plurality of exemplary embodiments of the inventive idea are shown in the accompanying drawing, in which:

FIG. 1 shows in longitudinal section a lip seal having a right-angled supporting body that has a dynamic seal and a static seal;

FIG. 2 shows a lip seal having a T-shaped supporting body;

FIG. 3 shows a lip seal having an L-shaped supporting body whose cylindrical section is doubled;

FIG. 4 shows a lip seal having a Z-shaped supporting body;

FIG. 5 shows a lip seal having a hook-shaped supporting body;

FIGS. 6, 7, 8 and 9 show lip seals having supporting bodies whose axial cylindrical parts include two sections that have different diameters; and

FIGS. 10 and 11 show two lip seals that are equipped with multipole wheels and sensors.

### DETAILED DESCRIPTION

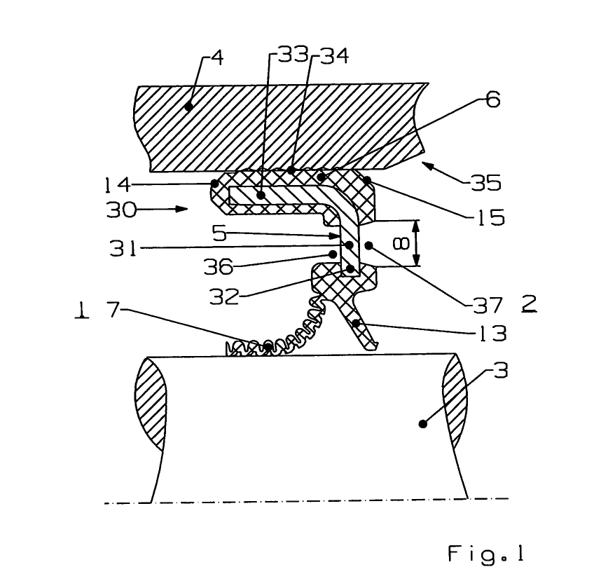

FIG. 1 shows in longitudinal section a lip seal 30, which is inserted into the gap between housing 4 and shaft 3. Lip seal 30 includes supporting body 5 and the sealing elements attached to it, namely static sealing element 6 and dynamic sealing element 7. The two sealing elements 6 and 7 are manufactured from different materials. Dynamic sealing element 7 is fastened to annular part 31 of supporting body 5, an annular part that is oriented radially to shaft 3. At fastening point 32, sealing element 7 encloses annular part 31 on both sides, i.e., both from the inside and from the outside. The inside faces space 1, the space to be sealed off, while the outside faces environment 2. Naturally, the radially interior surface of annular part 31 has also been enclosed. Dynamic sealing element 7 is curved towards space 1, the space being sealed off. In the direction of environment 2, dynamic sealing element 7 is also provided with protective lip 13, which is used primarily to deflect dirt.

Static sealing element 6 is attached to axial cylindrical part 33 of supporting body 5. In the embodiment shown, static sealing element 6 encloses the entirety of axial cylindrical part 33 on both sides. On its outside 34, static sealing element 6 has end chamfer 14 and bottom chamfer 15. Both chamfers 14 and 15 facilitate the sliding of lip seal 30 into the existing hole in housing 4, which for its part is also provided with a chamfer, chamfer 35.

Between static sealing element 6 and dynamic sealing element 7, there is radial distance 8, which is on both the side facing space 1 and the side facing environment 2. Radial distance 8 may be the same for two ring grooves 36 and 37 that run around the circumference of radial annular part 31 and lie opposite one another.

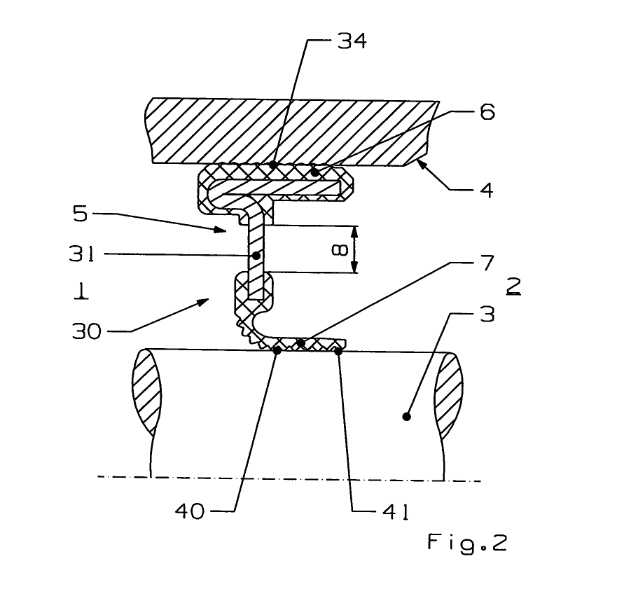

In the exemplary embodiment shown in FIG. 2, the basic design of lip seal 30, as shown in FIG. 1, has been retained, with the difference that dynamic sealing element 7 has no protective lip and in this case is curved towards environment 2. When viewed in section, supporting body 5 is T-shaped in design. The metal sheet used for supporting body 5 is folded appropriately for this purpose. The lip that encloses shaft 3, and, more particularly, lip surface 40 that faces shaft 3, is provided with openings for return delivery of the medium being sealed off. Lip edge 41 is provided with a barrier feature that prevents the liquid medium from exiting space 1.

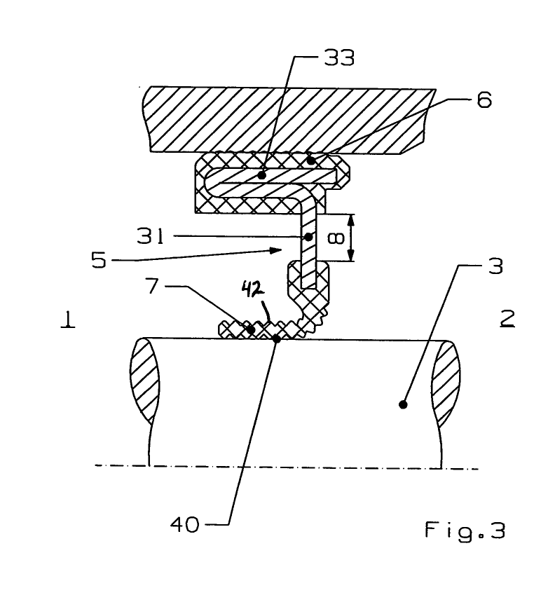

FIG. 3 shows an embodiment in which supporting body 5 is L-shaped when viewed in section but has a reinforced axial cylindrical part 33. This is achieved by doubling over supporting body 5 at this point. Dynamic sealing element 7 is curved towards interior space 1, and in its lip area, both on surface 40 facing shaft 3 and on surface 42 facing away from shaft 3, it is provided with openings. The double-sided placement of openings results in a better bending capability for dynamic sealing element 7, in particular in the case of harder materials.

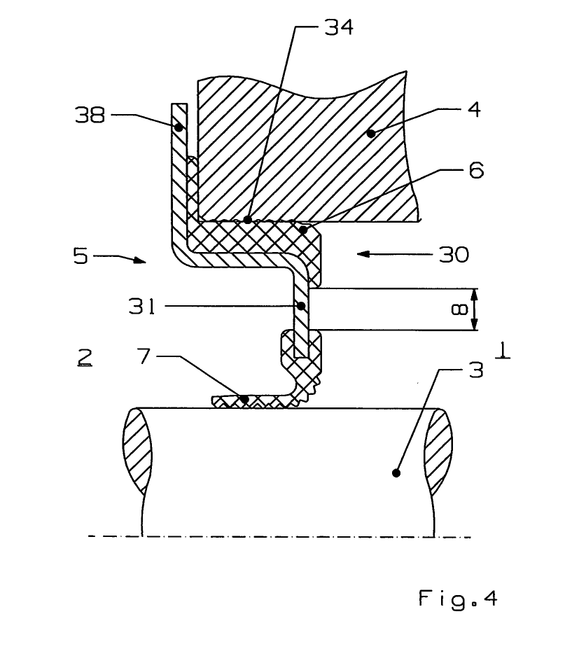

FIG. 4 shows an exemplary embodiment in which supporting body 5 is Z-shaped when viewed in section. Static sealing element 6 in this embodiment is provided only on the side of supporting body 5 that faces housing 4. Flange 38 of supporting body 5, a flange which is located on the outside radially, is used as the axial stop when seal 30 is installed between housing 4 and shaft 3. During installation, seal 30 is pushed from the direction of environment 2 into the gap between housing 4 and shaft 3. In this case, dynamic sealing element 7 is curved towards environment 2. The design of static sealing element 6 and of dynamic sealing element 7 otherwise corresponds substantially to the elements shown in FIG. 2.

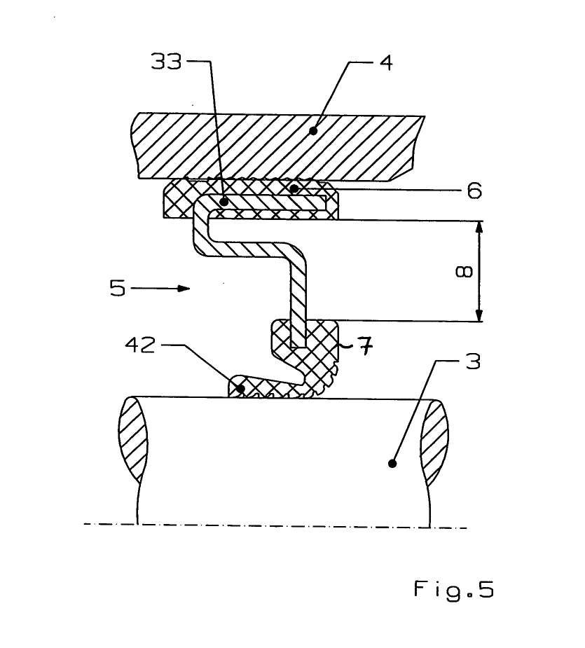

The embodiment shown in FIG. 5 is a lip seal that is designed for installation spaces extending over a large radial distance. Supporting body 5 has the shape of a hook when viewed in section, and static sealing element 6 is attached only to axial cylindrical part 33, which protrudes towards the outside. In this embodiment, a considerably greater distance between static sealing element 6 and dynamic sealing element 7 may be maintained. In this case it is advantageous if dynamic sealing element 7 has an increasing thickness at its free end 42.

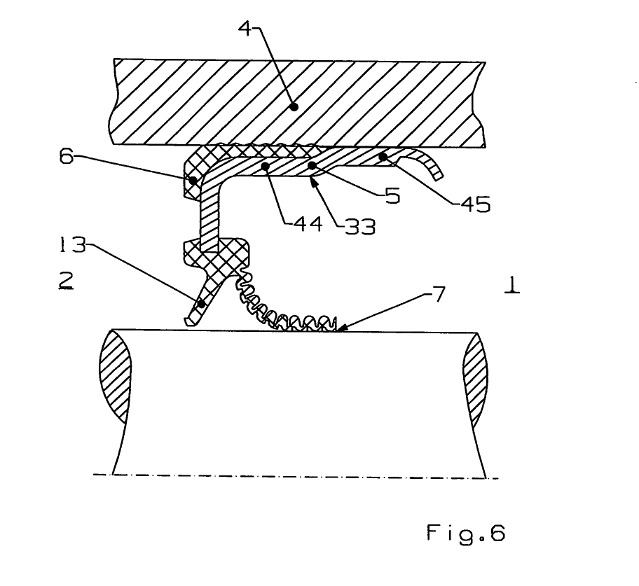

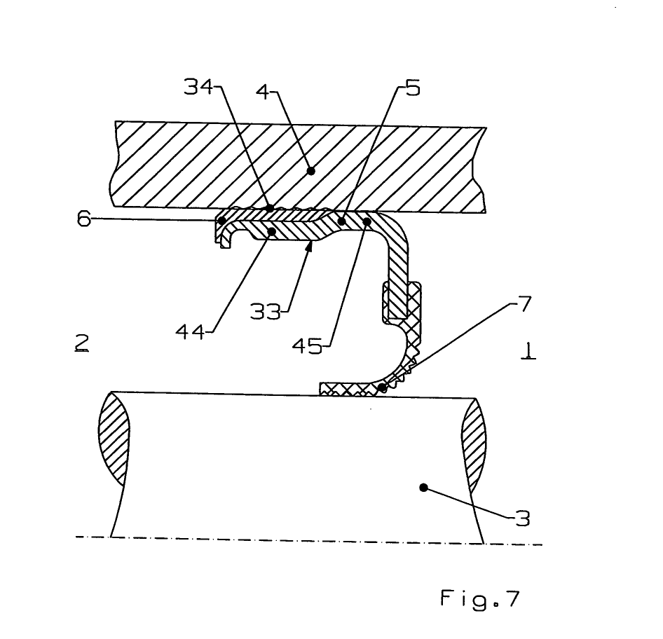

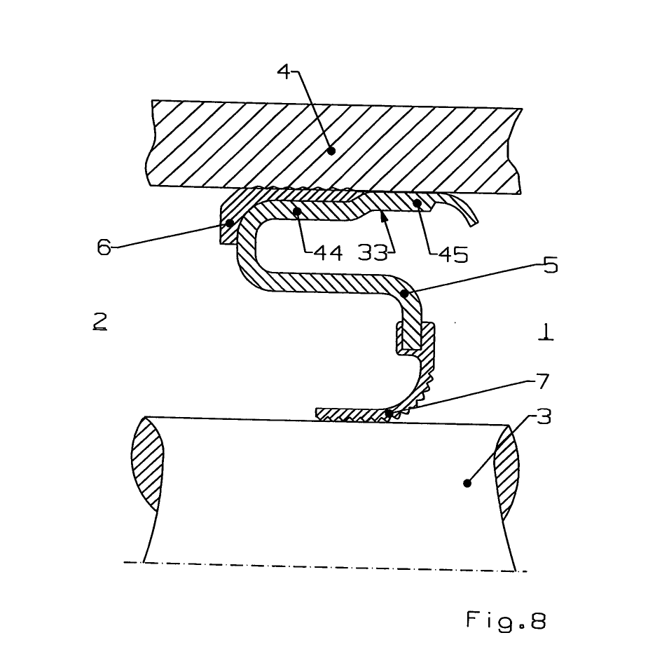

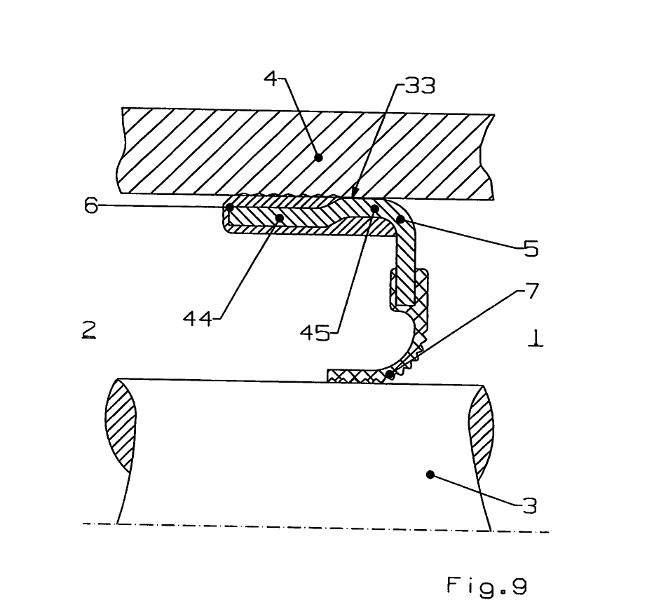

FIGS. 6, 7, 8 and 9 show a plurality of embodiments of lip seals that have different supporting bodies 5 having static sealing elements 6 and dynamic sealing elements 7 attached to them in different ways. Supporting bodies 5 in these embodiments have two different sections 44 and 45 on axial cylindrical part 33. Sections 44 have a smaller diameter than sections 45. A design of this type is advantageous if, in addition to the good static seal 6 in the housing hole, the goal is also to achieve a very tight fit of supporting body 5 in the housing hole by having supporting body 5, and more particularly its section 45, with its outside surface directly in the housing hole, bear against housing 4.

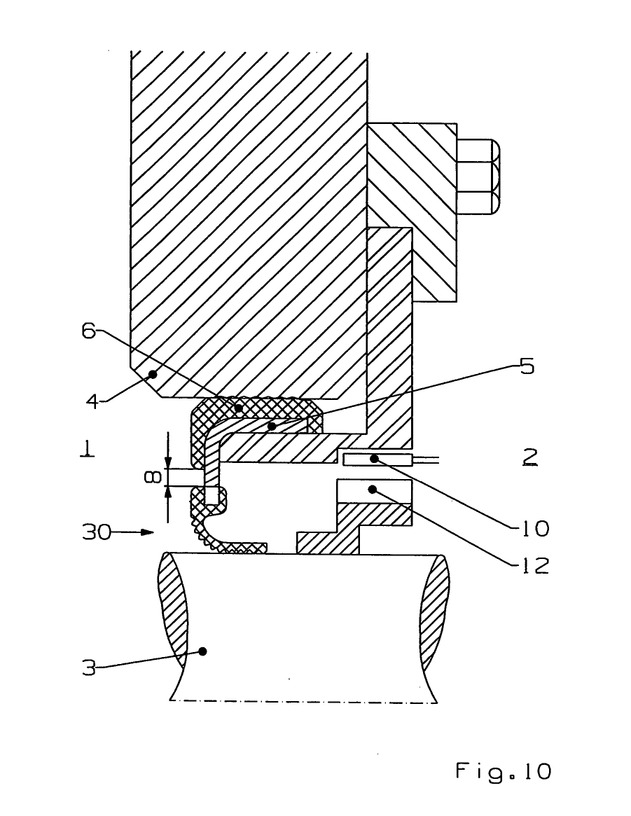

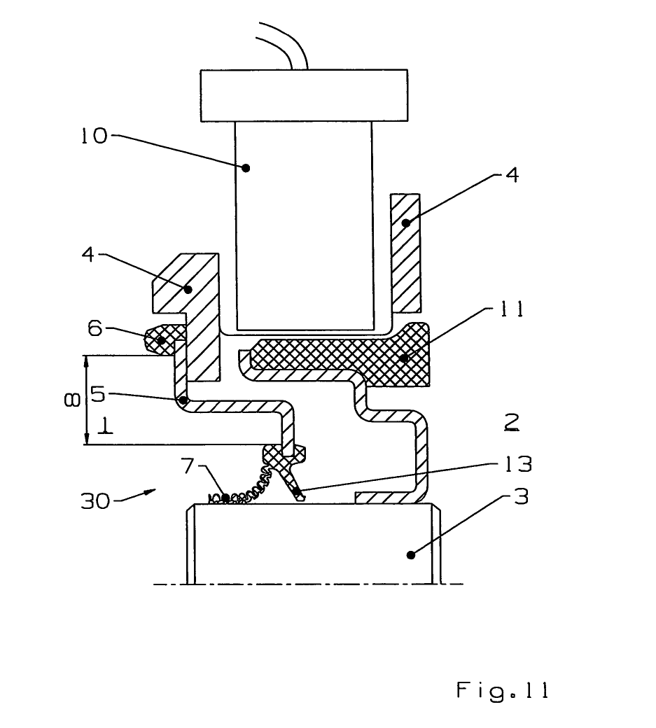

In the exemplary embodiments in FIGS. 10 and 11, lip seals 30 are supplemented by measuring devices that substantially include a multipole wheel 11 (see FIG. 11) or sensor wheel 12 (FIG. 10) fastened to shaft 3 and a sensor 10 located opposite these wheels. Rotational speeds, rotational inaccuracies and the like may be measured and detected with these devices.

What is claimed is:

1. A lip seal for sealing a gap between a housing and a shaft comprising:
a supporting body, the supporting body having an annular part oriented radially to the shaft and a cylindrical part running axially to the shaft, the annular part having two opposing sides;
a static sealing element attached to the supporting body; and
a dynamic sealing element attached to the supporting body, the dynamic sealing element being made of a different material than the static sealing element;
the dynamic sealing element being fastened to the annular part and enclosing the annular part on the two opposing sides at a fastening point;
the static sealing element being positioned on the cylindrical part at a radial distance from the dynamic sealing element.

2. The lip seal as recited in claim 1 wherein the supporting body is made from a rigid material.

3. The lip seal as recited in claim 2 wherein the rigid material is metal.

4. The lip seal as recited in claim 1 wherein the radial distance between the static sealing element and the dynamic sealing element is at least 0.5 mm.

5. The lip seal as recited in claim 1 wherein the static and dynamic sealing elements are connected to the supporting body by vulcanization using a coupling agent.

6. The lip seal as recited in claim 1 wherein the dynamic sealing element receives a lip shape during sliding of the seal onto the shaft.

7. The lip seal as recited in claim 1 wherein the dynamic sealing element has a lip enclosing the shaft, the lip having a lip surface facing the shaft, and wherein the lip is provided with openings on the lip surface for return delivery of a medium to be sealed off.

8. The lip seal as recited in claim 1 the dynamic sealing element has a lip edge with a barrier feature.

9. The lip seal as recited in claim 1 wherein the dynamic sealing element has a surface facing away from the shaft, the surface having concentric or screw-shaped openings.

10. The lip seal as recited in claim 9 wherein the openings are single-threaded or multiple-threaded.

11. The lip seal as recited in claim 1 wherein the dynamic sealing element has a lip curved towards an environment or towards a sealed-off space.

12. The lip seal as recited in claim 1 wherein the static sealing element has at least one of an end chamfer and a bottom chamfer on an outside surface.

13. The lip seal as recited in claim 1 wherein static sealing element has an outside surface, the outside surface being corrugated.

14. The lip seal as recited in claim 1 further comprising a sensor attached to the housing and a sensor wheel or a multipole wheel on the shaft interacting with the sensor.

15. A method for manufacturing a lip seal for sealing a gap between a housing and a shaft, the lip seal having a supporting body, the supporting body having an annular part oriented radially to the shaft and a cylindrical part running axially to the shaft, the annular part having two opposing sides, the lip seal further having a static sealing element attached to the supporting body and a dynamic sealing element attached to the supporting body, the dynamic sealing element being made of a different material than the static sealing element, the method comprising the steps of:
fastening the dynamic sealing element to the annular part and enclosing the annular part on the two opposing sides at a fastening point; and
positioning the static sealing element on the cylindrical part at a radial distance from the dynamic sealing element.

16. A method for sealing a gap between a housing and a shaft using a lip seal, the lip seal having a supporting body, the supporting body having an annular part oriented radially to the shaft and a cylindrical part running axially to the shaft, the annular part having two opposing sides, the lip seal further having a static sealing element attached to the supporting body and a dynamic sealing element attached to the supporting body, the dynamic sealing element being made of a different material than the static sealing element, the dynamic sealing element being fastened to the annular part and enclosing the annular part on the two opposing sides at a fastening point and the static sealing element being positioned on the cylindrical part at a radial distance from the dynamic sealing element; the method comprising the steps of:
contacting the housing with the static sealing element; and
contacting the shaft with the dynamic sealing element.
